(19) United States
(12) Patent Application Publication
(10) Pub. No.: US 2025/0097333 A1
(43) Pub. Date: Mar. 20, 2025

(54) ELECTRONIC APPARATUS AND METHOD FOR MANUFACTURING THE SAME

(71) Applicant: Samsung Display Co., Ltd., Yongin-si (KR)

(72) Inventor: GEUNWOO YUG, Yongin-si (KR)

(73) Assignee: Samsung Display Co., Ltd., Yongin-si (KR)

(21) Appl. No.: 18/767,537

(22) Filed: Jul. 9, 2024

(30) Foreign Application Priority Data
Sep. 19, 2023 (KR) 10-2023-0124658

(51) Int. Cl. H04M 1/02

(52) U.S. Cl. CPC H04M 1/0268; H04M 1/0214

(57) ABSTRACT

An electronic apparatus which is divided into a folding region foldable with respect to a folding axis extending in a direction, a first non-folding region adjacent to a side of the folding region, and a second non-folding region adjacent to another side of the folding region includes a lower module, a display panel disposed on the lower module, and a window disposed on the display panel. In a first cross-sectional view parallel to a thickness direction of the display panel and perpendicular to the folding axis, a first side surface of the display panel is inclined with respect to a lower surface of the display panel. Accordingly, the electronic apparatus may exhibit excellent display quality.

### CROSS-REFERENCE TO RELATED APPLICATION(S)

This application claims priority to and benefits of Korean Patent Application No. 10-2023-0124658 under 35 U.S.C. § 119, filed on Sep. 19, 2023, in the Korean Intellectual Property Office, the entire contents of which are incorporated herein by reference.

### BACKGROUND

### 1. Technical Field

The disclosure herein relates to a foldable electronic apparatus and a method for manufacturing the same.

### 2. Description of the Related Art

Various electronic apparatuses such as televisions, mobile phones, tablet computers, game consoles, or the like have been developed. Recently, flexible electronic apparatuses including flexible display panels, which are capable of sliding or folding, have been developed. Unlike rigid display devices, flexible electronic apparatuses are capable of folding, rolling, or bending. Since flexible electronic apparatuses, which are deformable into various shapes, may be carried regardless of the size of existing screens, user's convenience is improved.

A foldable electronic apparatus among flexible electronic apparatuses is required to maintain the reliability and safety of members constituting the electronic apparatus when folded, and in consideration thereof, a peripheral region in which images are not displayed is designed. A peripheral region of an electronic apparatus may degrade display quality, and accordingly a measure to reduce the peripheral region is required.

### SUMMARY

The disclosure provides an electronic apparatus with improved display quality and a method for manufacturing the same.

According to an embodiment of the disclosure, an electronic apparatus divided into a folding region foldable with respect to a folding axis extending in a direction, a first non-folding region adjacent to a side of the folding region, and a second non-folding region adjacent to another side of the folding region, the electronic apparatus may include a lower module; a display panel disposed on the lower module; and a window disposed on the display panel. In a first cross-sectional view parallel to a thickness direction and perpendicular to the folding axis, a first side surface of the display panel may be inclined with respect to a lower surface of the display panel.

In an embodiment, in the first cross-sectional view, an angle formed between the first side surface and the lower surface may be in a range of about 65° to about 80°.

In an embodiment, in a second cross-sectional view parallel to the thickness direction and the folding axis, a second side surface of the display panel may be perpendicular to the lower surface of the display panel.

In an embodiment, in a view perpendicular to the thickness direction, the first side surface of the display panel may intersect the second side surface of the display panel.

In an embodiment, the electronic apparatus may further include a protective layer disposed on the window. In the first cross-sectional view, a first side surface of the protective layer may be inclined with respect to a lower surface of the protective layer.

In an embodiment, in the first cross-sectional view, an angle formed between the first side surface of the protective layer and the lower surface of the protective layer may be in a range of about 65° to about 80°.

In an embodiment, in a second cross-sectional view parallel to the thickness direction and the folding axis, a second side surface of the protective layer may be perpendicular to the lower surface of the protective layer.

In an embodiment, in a view perpendicular to the thickness direction, the first side surface of the protective layer may intersect the second side surface of the protective layer.

In an embodiment, the electronic apparatus, in a first mode, may be folded so that the first non-folding region overlaps the second non-folding region in the thickness direction, and in a second mode, may be unfolded so that the first non-folding region is spaced apart from the second non-folding region. In the second mode, the first side surface of the display panel may be parallel to the first side surface of the protective layer.

In an embodiment, in the first mode, the first side surface of the display panel may not be parallel to the first side surface of the protective layer.

In an embodiment, the window may include a glass substrate, and in the first cross-sectional view, a side surface of the window may be perpendicular to a lower surface of the window.

In an embodiment, the electronic apparatus may further include an optical layer disposed between the display panel and the window. In the first cross-sectional view, a side surface of the optical layer may be inclined with respect to a lower surface of the optical layer.

In an embodiment, the lower module may include a support plate and a lower film disposed between the support plate and the display panel.

In an embodiment, in the first cross-sectional view, a side surface of the support plate may be inclined with respect to a lower surface of the support plate.

In an embodiment of the disclosure, a method for manufacturing an electronic apparatus, the method may include preparing a preliminary lower module, providing a preliminary display panel on the preliminary lower module, providing a window on the preliminary display panel, and forming a display panel by providing laser and removing an edge region of the preliminary display panel. The preliminary display panel may be divided into a folding part foldable with respect to a folding axis extending in a direction and a non-folding part adjacent to the folding part, the edge region of the preliminary display panel may correspond to a portion of the non-folding part, and in a cross-sectional view parallel to a thickness direction of the display panel and perpendicular to the folding axis, a side surface of the display panel may be inclined with respect to a lower surface of the display panel.

In an embodiment, the laser may be provided in a state of being inclined with respect to the thickness direction at an angle in a range of about 10° to about 25°.

In an embodiment, the method may further include providing a preliminary protective layer on the window between the providing of the window and the forming of the display panel. In the forming of the display panel, a protective layer may be formed by removing an edge region of the preliminary protective layer, and the edge region of the preliminary protective layer may overlap a portion of the non-folding part in the thickness direction.

In an embodiment, the window may include a glass substrate, and the laser may not be provided to the window.

In an embodiment, in the cross-sectional view, an angle formed between the side surface and the lower surface of the display panel may be in a range of about 65° to about 80°.

In an embodiment, in the forming of the display panel, a lower module may be formed by removing, with the laser, an edge region of the preliminary lower module.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain principles of the disclosure. In the drawings:

FIG. 1A is a perspective view illustrating an electronic apparatus according to an embodiment;

FIG. 1B is a perspective view illustrating an electronic apparatus according to an embodiment;

FIG. 1C is a plan view illustrating an electronic apparatus according to an embodiment;

FIG. 1D is a perspective view illustrating an electronic apparatus according to an embodiment;

FIG. 2A is a perspective view illustrating an electronic apparatus according to an embodiment;

FIG. 2B is a perspective view illustrating an electronic apparatus according to an embodiment;

FIG. 2C is a perspective view illustrating an electronic apparatus according to an embodiment;

FIG. 3 is an exploded perspective view illustrating an electronic apparatus according to an embodiment;

FIG. 4 is a schematic cross-sectional view taken along line I-I′ of FIG. 3;

FIG. 5 is a schematic cross-sectional view taken along line II-II′ of FIG. 3;

FIG. 6 is a schematic cross-sectional view taken along line III-III′ of FIG. 3;

FIG. 7 is a plan view illustrating a portion of an electronic apparatus according to an embodiment;

FIG. 8 is a plan view illustrating a portion of an electronic apparatus according to an embodiment;

FIG. 9 is a schematic cross-sectional view taken along line X-X′ of FIG. 1C;

FIG. 10 is a schematic cross-sectional view illustrating an electronic apparatus according to an embodiment;

FIG. 11 is a flowchart illustrating a method of manufacturing an electronic apparatus according to an embodiment;

FIG. 12 is a schematic cross-sectional view schematically illustrates operations of manufacturing an electronic apparatus according to an embodiment; and

FIG. 13 is a schematic cross-sectional view schematically illustrates operations of manufacturing an electronic apparatus according to an embodiment.

### DETAILED DESCRIPTION OF THE EMBODIMENTS

The disclosure may be implemented in various modifications and have various forms and specific embodiments are illustrated in the drawings and described in detail in the text. It is to be understood, however, that the disclosure is not intended to be limited to the particular forms disclosed, but on the contrary, is intended to cover all modifications, equivalents, and alternatives falling within the spirit and scope of the disclosure.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

Like numbers or symbols refer to like elements throughout. Also, in the drawings, the thicknesses, ratios, and dimensions of the elements are exaggerated for effective description of the technical contents. In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Although the terms first, second, etc. may be used to describe various elements, these elements should not be limited by these terms. These terms are only used to distinguish one element from another element. For example, a first element may be referred to as a second element, and similarly, a second element may also be referred to as a first element without departing from the scope of the disclosure. The singular forms include the plural forms as well, unless the context clearly indicates otherwise.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

Unless otherwise defined, all terms (including technical and scientific terms) used herein have the same meaning as commonly understood by one of ordinary skills in the art to which the disclosure belongs. Also, terms, such as those defined in commonly used dictionaries, should be interpreted as having a meaning that is consistent with their meaning in the context of the relevant art and should not be interpreted in an idealized or overly formal sense unless expressly so defined herein.

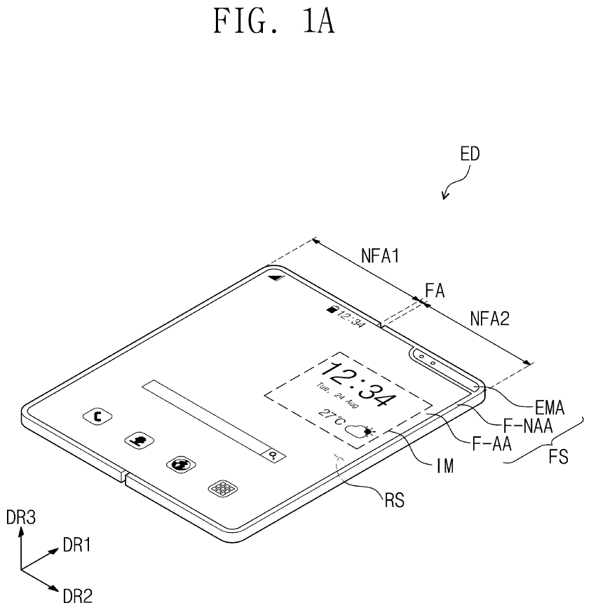

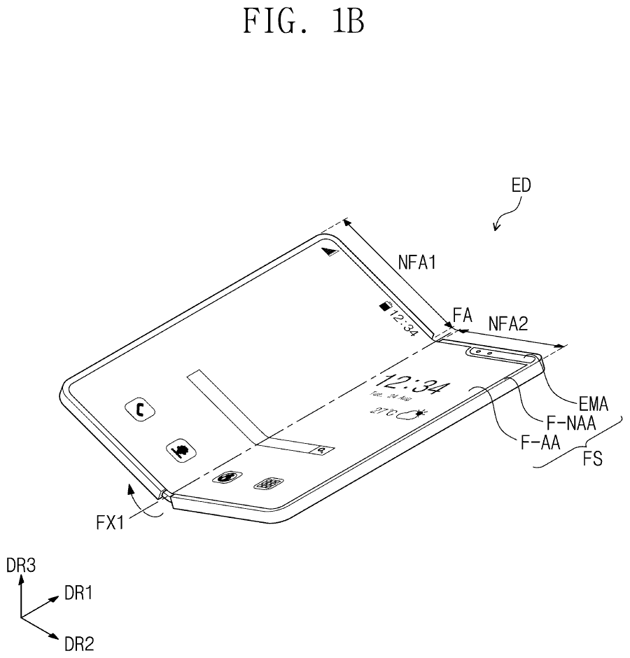

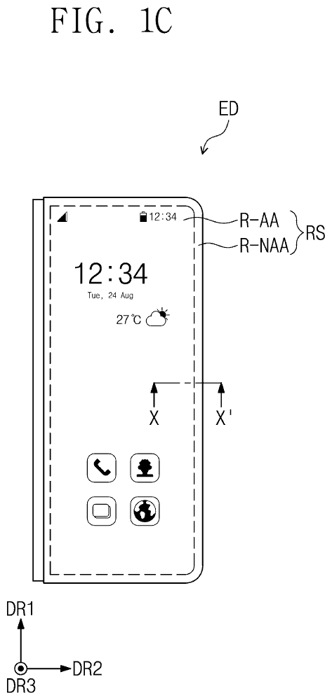

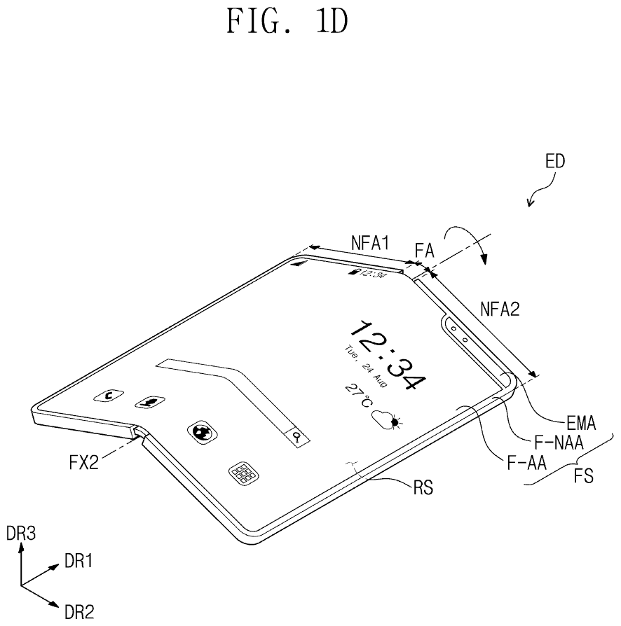

Hereinafter, an electronic apparatus according to an embodiment of the disclosure will be described with reference to the drawings. FIG. 1A is a perspective view illustrating an unfolded state of an electronic apparatus ED according to an embodiment.

An electronic apparatus ED according to an embodiment may be activated in response to an electrical signal. For example, the electronic apparatus ED may be a mobile phone, a tablet PC, a car navigation system, a game console, or a wearable device, but the disclosure is not limited thereto. In FIG. 1A and the like, the electronic apparatus ED is illustrated as a mobile phone.

The electronic apparatus ED may include a first display surface FS defined by a first direction axis DR1 and a second direction axis DR2 intersecting the first direction axis DR1. The electronic apparatus ED may provide an image IM through the first display surface FS. The electronic apparatus ED may display the image IM in a third direction axis DR3 on the first display surface FS which is parallel to each of the first direction axis DR1 and the second direction axis DR2.

In this specification, the first direction axis DR1 and the second direction axis DR2 may be perpendicular to each other, and the third direction axis DR3 may be the normal direction of a plane defined by the first direction axis DR1 and the second direction axis DR2. A thickness direction of the electronic apparatus ED may be parallel to the third direction axis DR3. A front surface (or a top surface) and a rear surface (or a bottom surface) may be opposed to each other in the third direction axis DR3, and the normal direction of each of a front surface (or a top surface) and a rear surface (or a bottom surface) may be parallel to the third direction axis DR3. A front surface (or a top surface) may be a surface close to the first display surface FS, and a rear surface (or a bottom surface) may be a surface spaced apart from the first display surface FS. A rear surface (or a bottom surface) may be a surface close to a second display surface RS to be described below. An above (or an upper portion) may be a direction getting closer to the first display surface FS, and a below (or a lower portion) may be a direction getting farther away from the first display surface FS.

A cross section may be a surface parallel to the thickness direction DR3, and a plane may be a surface perpendicular to the thickness direction DR3. A plane may be a surface defined by the first direction axis DR1 and the second direction axis DR2.

The directions indicated by the first to third direction axes DR1, DR2, and DR3 illustrated in this specification may be a relative concept and may thus be changed to other directions. The directions indicated by the first to third direction axes DR1, DR2, and DR3 may be referred to as first to third directions, and may thus be denoted as the same reference numerals or symbols.

The electronic apparatus ED may sense an external input applied from the outside. The external input may include various forms of inputs supplied from the outside of the electronic apparatus ED. For example, the external input may include external inputs (for example, hovering) applied close to the electronic apparatus ED or adjacent by a distance to the electronic apparatus ED as well as a touch by a user's body part such as a hand or the like. The external input may have various forms such as physical force, pressure, heat, light, etc.

The electronic apparatus ED may include the first display surface FS and the second display surface RS. The first display surface FS may include a first active region F-AA, a first peripheral region F-NAA, and an electronic module region EMA. The second display surface RS may be a surface facing at least a portion of the first display surface FS. For example, the second display surface RS may be a portion of a rear surface of the electronic apparatus ED.

The first active region F-AA may be activated in response to an electrical signal. The first active region F-AA may be a region in which the image IM is displayed and various forms of external inputs may be sensed.

The first peripheral region F-NAA may be a region in which the image IM is not displayed. The first peripheral region F-NAA may be adjacent to the first active region F-AA. The first peripheral region F-NAA may have a color. The first peripheral region F-NAA may surround the first active region F-AA in a plan view. Accordingly, a shape of the first active region F-AA may be defined substantially by the first peripheral region F-NAA. However, the disclosure is not limited thereto, and the first peripheral region F-NAA may be disposed adjacent to only a side of the first active region F-AA, or may be omitted.

Various electronic modules may be disposed in the electronic module region EMA. For example, an electronic module may include at least one of a camera, a speaker, a light detecting sensor, or a heat detecting sensor. The electronic module region EMA may sense an external subject received through the display surfaces FS and RS or may provide an audio signal of a voice or the like to the outside through the display surfaces FS and RS. The electronic module may include multiple components, but the disclosure is not limited to any one embodiment.

The electronic module region EMA may be surrounded by the first peripheral region F-NAA in a plan view. However, and the disclosure is not limited thereto. For example, the electronic module region EMA may be surrounded by the first active region F-AA and the first peripheral region F-NAA in a plan view, and the electronic module region EMA may be disposed in the first active region F-AA.

The electronic apparatus ED according to an embodiment may be divided into at least one folding region FA and multiple non-folding regions NFA1 and NFA2 which extend from the folding region FA. For example, a first non-folding region NFA1, the folding region FA, and a second non-folding region NFA2 may be defined along the second direction DR2. The electronic apparatus ED may be divided into the first non-folding region NFA1 and the second non-folding region NFA2 which are spaced apart from each other with the folding region FA between the first non-folding region NFA1 and the second non-folding region NFA2 in the second direction DR2. For example, the first non-folding region NFA1 may be disposed on a side of the folding region FA in the second direction DR2, and the second non-folding region NFA2 may be disposed on another side of the folding region FA in the second direction DR2.

FIG. 1A, etc., schematically illustrates an embodiment of the electronic apparatus ED including one folding region FA, but the disclosure is not limited thereto. In another embodiment, multiple folding regions may be defined in the electronic apparatus ED. For example, an electronic apparatus according to an embodiment may include two or more folding regions, or may include three or more non-folding regions disposed with the folding regions between non-folding regions respectively.

FIG. 1B is a perspective view illustrating a folding operation of the electronic apparatus ED according to an embodiment. FIG. 1C is a plan view illustrating a folded state of the electronic apparatus ED according to an embodiment. FIG. 1D is a perspective view illustrating a folding operation of the electronic apparatus ED according to an embodiment.

Referring to FIG. 1B, the electronic apparatus ED according to an embodiment may be folded with respect to a first folding axis FX1 extending in the first direction DR1. In a folded state of the electronic apparatus ED, the folding region FA may have a curvature and a radius of curvature. The electronic apparatus ED may be folded with respect to the first folding axis FX1, and deformed into an in-folded state so that the first non-folding region NFA1 and the second non-folding region NFA2 face each other and the first display surface FS is not exposed to the outside.

Referring to FIG. 1C, the second display surface RS may be viewed by a user in an in-folded state of the electronic apparatus ED according to an embodiment. The second display surface RS may include a second active region R-AA which displays an image. The second active region R-AA may be activated in response to an electrical signal. The second active region R-AA may be a region in which an image is displayed and various forms of external inputs may be sensed.

The second display surface RS may include a second peripheral region R-NAA. The second peripheral region R-NAA may be adjacent to the second active region R-AA. The second peripheral region R-NAA may have a color. The second peripheral region R-NAA may surround the second active region R-AA in a plan view. Although not illustrated herein, the electronic apparatus ED may further include, in the second display surface RS, an electronic module region in which an electronic module having various components is disposed, but the disclosure is not limited thereto.

Referring to FIG. 1D, the electronic apparatus ED according to an embodiment may be folded with respect to a second folding axis FX2 extending in the first direction DR1. The electronic apparatus ED may be folded with respect to the second folding axis FX2 and deformed to an out-folded state so that the first display surface FS is exposed to the outside. In an embodiment, the electronic apparatus ED may be configured to mutually repeat an in-folding operation or an out-folding operation from an unfolding operation, but the disclosure is not limited thereto.

In a plan view, a folded state in which the electronic apparatus ED is folded so that the first non-folding region NFA1 and the second non-folding region NFA2 overlap each other may be defined as a first mode. An unfolded state in which the first non-folding region NFA1 and the second non-folding region NFA2 are spaced apart from each other may be defined as a second mode. FIG. 1C schematically illustrates the electronic apparatus ED in the first mode. FIG. 1A schematically illustrates the electronic apparatus ED in the second mode.

FIGS. 1A to ID schematically illustrate that the electronic apparatus is folded with respect to one folding axis FX1 or FX2, but the number of folding axes and the number of non-folding regions corresponding thereto are not limited thereto. For example, an electronic apparatus may be folded with respect to multiple folding axes and a portion of the first display surface FS and a portion of the second display surface RS may face each other. The first and second folding axes FX1 and FX2 are illustrated to be parallel to a long side of the electronic apparatus ED, but the disclosure is not limited thereto. In another embodiment, the first and second folding axes FX1 and FX2 may be parallel to a short side of the electronic apparatus ED.

In the electronic apparatus ED, as illustrated in FIG. 1C, the first non-folding region NFA1 and the second non-folding region NFA2 may be defined as parts which have display surfaces FS and RS parallel to a plane defined by the first direction axis DR1 and the second direction axis DR2 in a folded state. The folding region FA may be defined as a region between the first non-folding region NFA1 and the second non-folding region NFA2. The folding region FA may include a curved part which may be curved to have a curvature in a folded state.

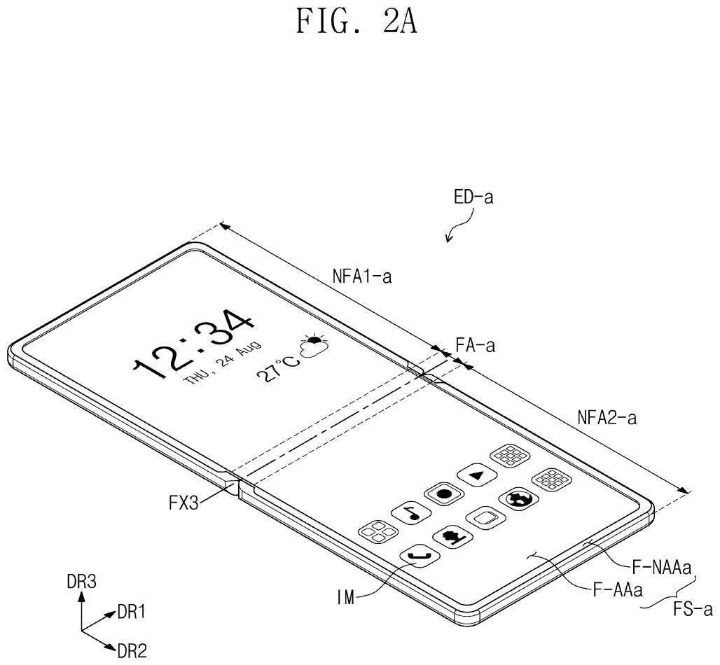

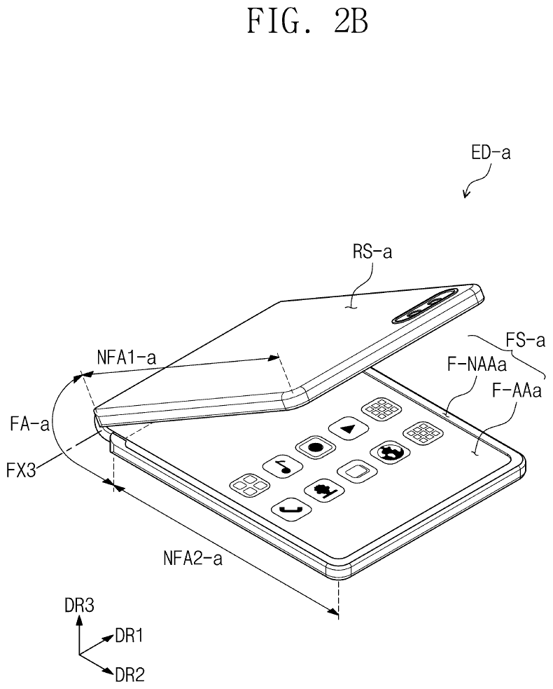

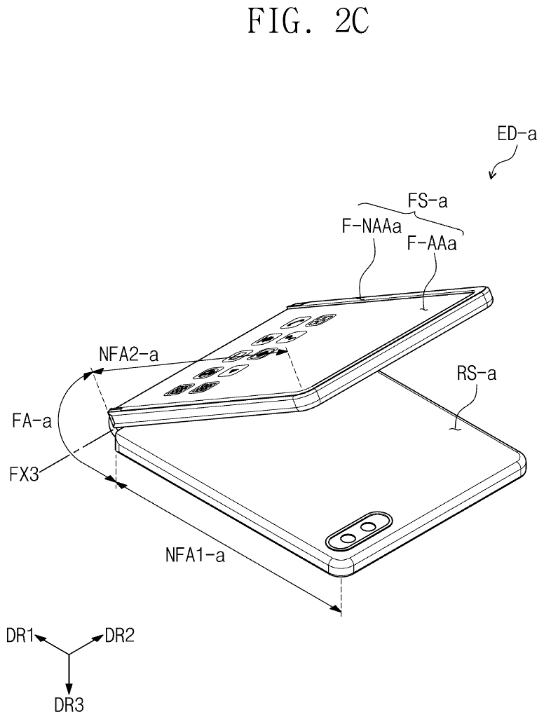

FIGS. 2A to 2C are perspective views illustrating an electronic apparatus ED-a according to another embodiment of the disclosure. FIG. 2A is a perspective view illustrating an unfolded state of the electronic apparatus ED-a. FIGS. 2B and 2C are perspective views illustrating a folding operation of the electronic apparatus ED-a. FIG. 2B is a perspective view illustrating an in-folding operation of the electronic apparatus ED-a illustrated in FIG. 2A. FIG. 2C is a perspective view illustrating an out-folding operation of the electronic apparatus ED-a illustrated in FIG. 2A. FIG. 2A schematically illustrates the electronic apparatus ED-a in a second mode.

The electronic apparatus ED-a may be folded with respect to a third folding axis FX3 parallel to the first direction axis DR1. Referring to FIG. 2A, an extending direction of the third folding axis FX3 may be parallel to an extending direction of a short side of the electronic apparatus ED-a.

The electronic apparatus ED-a may be divided into a folding region FA-a, a first non-folding region NFA1-a adjacent to a side of the folding region FA-a, and a second non-folding region NFA2-a adjacent to another side of the folding region FA-a. The first non-folding region NFA1-a and the second non-folding region NFA2-a may be spaced apart from each other with the folding region FA-a between the first non-folding region NFA1-a and the second non-folding region NFA2.

The folding region FA-a may be a region foldable with respect to the third folding axis FX3. In a folded state of the electronic apparatus ED-a, the folding region FA-a may have a curvature and a radius of curvature. The first non-folding region NFA1-a and the second non-folding region NFA2-a may face each other, and the electronic apparatus ED-a may be in-folded so that a display surface FS is not exposed to the outside.

Referring to FIG. 2A, in an embodiment, in an unfolded state of the electronic apparatus ED-a (for example, a state in which the electronic apparatus is not folded), a display surface FS-a may be viewed by a user. As described with reference to FIGS. 1A to ID, the display surface FS-a of the electronic apparatus ED-a may include an active region F-AAa and a peripheral region F-NAAa. The active region F-AAa may be a region in which an image IM is displayed and various forms of external inputs may be sensed.

Referring to FIG. 2B, in an in-folded state of the electronic apparatus ED-a according to an embodiment, a rear surface RS-a may be viewed by a user. For example, the rear surface RS-a may serve as a second display surface on which a video or an image is displayed. Although not illustrated, an electronic module region, in which an electronic module having various components is disposed, may be disposed in the rear surface RS-a.

Referring to FIG. 2C, the electronic apparatus ED-a may be folded with respect to the third folding axis FX3 and deformed into an out-folded state in which a region of the rear surface RS-a overlapping the first non-folding region NFA1-a and another region overlapping the second non-folding region NFA2-a face each other.

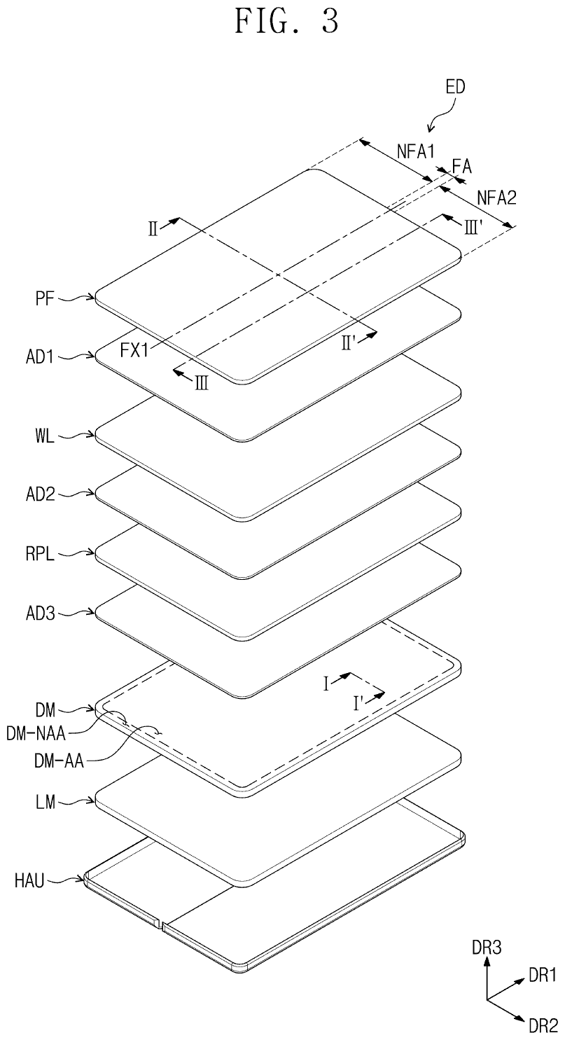

FIG. 3 is an exploded perspective view of the electronic apparatus ED illustrated in FIG. 1A. Hereinafter, a description of the electronic apparatus ED may be applied similarly to the electronic apparatus ED-a illustrated in FIGS. 2A to 2C.

Referring to FIG. 3, the electronic apparatus ED may include a lower module LM, a display module DM disposed on the lower module LM, and a window WL disposed on the display module DM. The electronic apparatus ED may further include a housing HAU, an optical layer RPL, and a protective layer PF.

The housing HAU may be disposed on a lower side of the lower module LM. The housing HAU may include a material having relatively high rigidity. For example, the housing HAU may include multiple frames and/or plates composed of glass, plastic, or metal. The housing HAU may provide an accommodation space. The display module DM may be accommodated in the accommodation space and protected from an external impact.

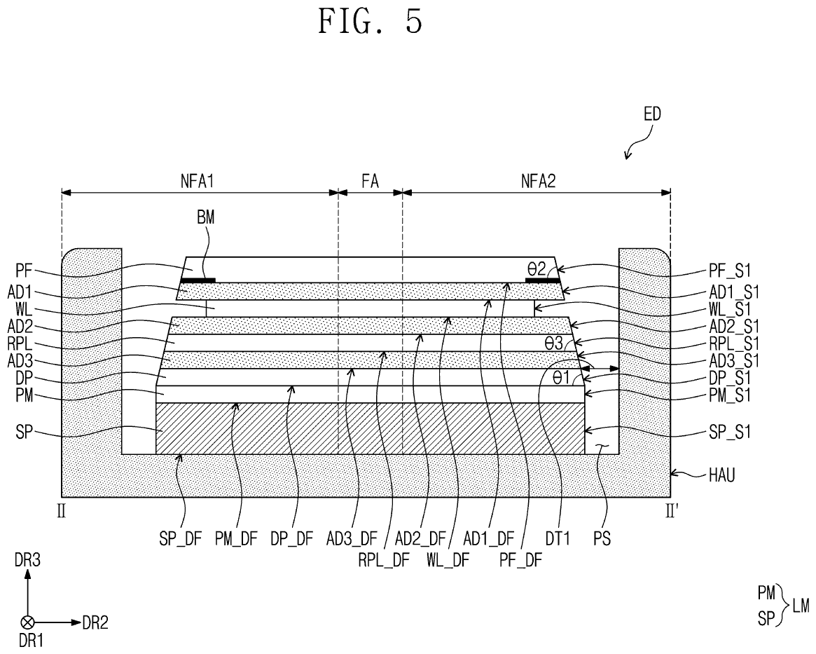

The lower module LM may include a support plate SP (see FIG. 5) and a lower film PM (see FIG. 5) which will be described below. Although not illustrated herein, the lower module LM may further include a cushion layer, a shielding layer, or the like. The cushion layer may prevent the support plate SP (see FIG. 5) from being pressed and plastically deformed due to an external impact and force. The cushion layer may include an elastomer such as a sponge, a foam, or a urethane resin. The cushion layer may include at least one of an acrylate-based polymer, a urethane-based polymer, a silicon-based polymer, and an imide-based polymer. The shielding layer may be an electromagnetic shielding layer or a heat dissipation layer.

The display module DM may be activated in response to an electrical signal. The display module DM may be activated and may display the image IM (see FIG. 1A) in the active region F-AA (see FIG. 1A) of the electronic apparatus ED. A display region DM-AA and a non-display region DM-NAA may be defined in the display module DM. The display region DM-AA may be activated in response to an electrical signal. The non-display region DM-NAA may be a region positioned adjacent to at least one side of the display region DM-AA. A circuit, a wire, or the like for driving the display region DM-AA may be disposed in the non-display region DM-NAA.

The optical layer RPL may be disposed between the display module DM and the window WL. The optical layer RPL may be an antireflective layer that reduces the reflectivity for external light from the outside of the display module DM. The optical layer RPL may be formed on the display module DM through a continuous process. The optical layer RPL may include a polarizing plate or a color filter layer. For example, the optical layer RPL may include at least one of a phase retarder, a polarizer, a polarizing film, and a polarizing filter. In another embodiment, the optical layer RPL may include multiple color filters disposed in an arrangement and a black matrix adjacent to the color filters.

The image IM (see FIG. 1A) generated in the display module DM may pass through the window WL and may be provided to a user. The window WL may include an optically transparent insulating material. The window WL may include a polymer substrate or a glass substrate. The window WL may be made of polyimide, polyacrylate, polymethylmethacrylate, polycarbonate, polyethylenenaphthalate, polyvinylidene chloride, polyvinylidene difluoride, polystyrene, ethylene vinylalcohol copolymer, or a combination thereof. However, a material which the window WL includes is not limited thereto. For example, the window WL may be a tempered glass substrate which has been subjected to a strengthening treatment. The window WL may include ultra thin glass (UTG).

The protective layer PF may be a functional layer which protects a surface of the window WL. The protective layer PF may include a polymer film. The protective layer PF may include an anti-fingerprint coating agent, a hard coating agent, an anti-static agent, or the like.

The electronic apparatus ED may further include first to third adhesive layers AD1, AD2, and AD3. A first adhesive layer AD1 may be disposed between the window WL and the protective layer PF. A second adhesive layer AD2 may be disposed between the optical layer RPL and the window WL. A third adhesive layer AD3 may be disposed between the display module DM and the optical layer RPL. The first to third adhesive layers AD1, AD2, and AD3 may each include an adhesive such as a pressure sensitive adhesive (PSA), an optically clear adhesive (OCA), an optical clear resin (OCR), etc., but the disclosure is not limited thereto. In another embodiment, at least one of the first to third adhesive layers AD1, AD2, and AD3 may be omitted.

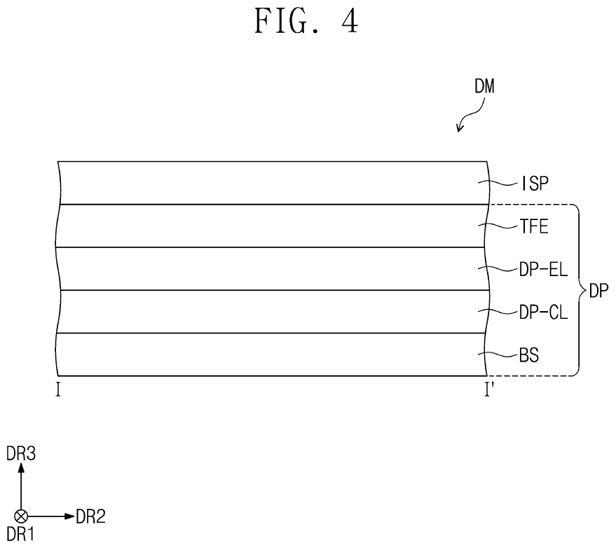

FIG. 4 is a schematic cross-sectional view taken along line I-I′ of FIG. 3. FIG. 4 is a schematic cross-sectional view illustrating the display module DM.

Referring to FIG. 4, the display module DM may include a display panel DP and an input sensing layer ISP disposed on the display panel DP. The display panel DP may be configured to substantially generate an image. The display panel DP may be a light-emitting display panel. For example, the display panel DP may be an organic light-emitting display panel, an inorganic light-emitting display panel, a micro-LED display panel, a micro OLED display panel, or a nano LED display panel.

The display panel DP may include a base layer BS, a circuit layer DP-CL, a display element layer DP-EL, and an encapsulation layer TFE which are sequentially stacked. In an embodiment, a functional layer may further be disposed between two adjacent layers among the base layer BS, the circuit layer DP-CL, the display element layer DP-EL, and the encapsulation layer TFE.

The base layer BS may provide a base surface on which the circuit layer DP-CL is disposed. The base layer BS may be a flexible substrate capable of bending, folding, rolling, or the like. The base layer BS may be a glass substrate, a metal substrate, a polymer substrate, or the like. However, the disclosure is not limited thereto, and the base layer BS may include an inorganic layer, an organic layer, or a composite material layer.

The base layer BS may include a single layer or multiple layers. For example, the base layer BS may include a first synthetic resin layer, a multi-layered or single-layered inorganic layer disposed on the first synthetic resin layer, and a second synthetic resin layer disposed on the multi-layered or single-layered inorganic layer. The first synthetic resin layer and the second synthetic resin layer may each include a polyimide-based resin. In another embodiment, the first synthetic resin layer and the second synthetic resin layer may each include at least one of an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, and a perylene-based resin. In this specification, a “˜˜based” resin may be considered as including a functional group of “˜˜”.

The circuit layer DP-CL may be disposed on the base layer BS. The circuit layer DP-CL may include an insulating layer, a semiconductor pattern, a conductive pattern, a signal line, and the like. The display element layer DP-EL may be disposed on the circuit layer DP-CL. The display element layer DP-EL may include a light-emitting element (not illustrated). For example, the light-emitting element may include an organic light-emitting material, an inorganic light-emitting material, an organic-inorganic light-emitting material, a quantum dot, a quantum rod, a micro-LED, or a nano LED.

The encapsulation layer TFE may be disposed on the display element layer DP-EL. The encapsulation layer TFE may protect the display element layer DP-EL against foreign matters such as moisture, oxygen, and dust particles. The encapsulation layer TFE may include at least one inorganic layer. For example, the encapsulation layer TFE may include an inorganic layer, an organic layer, and an inorganic layer which are sequentially stacked.

The input sensing layer ISP may be disposed on the display panel DP. The input sensing layer ISP may be disposed on (e.g., disposed directly on) the encapsulation layer TFE. In another embodiment, an adhesive member may be disposed between the input sensing layer ISP and the display panel DP.

In this specification, the wording that one component is disposed directly on another component means that a third component is not disposed between one component and another component. In other words, the wording that one component is “disposed directly” on another component means that one component comes into “contact” with another component.

The input sensing layer ISP may sense and change an external input into an input signal, and provide the input signal to the display panel DP. For example, the input sensing layer ISP may be a touch sensing layer which detects a touch. The input sensing layer ISP may perceive a direct touch of a user, an indirect touch of a user, a direct touch of an object, an indirect touch of an object, or the like.

The input sensing layer ISP may sense at least one of a location or an intensity (pressure) of the touch applied from the outside. The input sensing layer ISP may have various structures or may be composed of various materials, and is not limited to any one embodiment. For example, the input sensing layer ISP may sense an external input in a capacitive manner. The display panel DP may receive an input signal from the input sensing layer ISP, and may generate an image corresponding to the input signal.

FIG. 5 is a schematic cross-sectional view taken along line II-II′ of FIG. 3. FIG. 5 may be a schematic cross-sectional view illustrating a configuration of the electronic apparatus ED on a first cross section. In this specification, the first cross section may be a cross-sectional view parallel to a thickness direction DR3 and perpendicular to a direction in which a first folding axis FX1 extends (for example, a first direction DR1). FIG. 5 may be a schematic cross-sectional view illustrating a configuration of the electronic apparatus ED in a second mode. For example, FIG. 5 may be a schematic cross-sectional view illustrating a configuration of the electronic apparatus ED in case that the electronic apparatus ED is unfolded so that the first non-folding region NFA1 (see FIG. 1A) and the second non-folding region NFA2 (see FIG. 1A) are spaced apart from each other. FIG. 5 and subsequent drawings illustrate the display panel DP in which the input sensing layer ISP (see FIG. 4) is excluded from the configuration of the display module DM (see FIG. 4), for convenience of explanation.

Referring to FIG. 5, the electronic apparatus ED may further include a printing layer BM. The printing layer BM may be provided on a surface of the protective layer PF. In an embodiment, the printing layer BM may also be provided on a surface of the window WL. The printing layer BM may correspond to the first peripheral region F-NAA (see FIG. 1A). For example, the printing layer BM may include a black pigment or a black dye.

The lower module LM may include a support plate SP and a lower film PM. The lower film PM may be disposed between the support plate SP and the display panel DP. Although not illustrated herein, an adhesive member may be disposed between the display panel DP and the lower film PM and/or between the lower film PM and the support plate SP.

The support plate SP may be disposed on a lower side of the display panel DP. The support plate SP may include a metal material or a polymer material. For example, the support plate SP may include stainless steel, aluminum, or an alloy thereof. In another embodiment, the support plate SP may include a polymer material.

The lower film PM may protect a lower portion of the display panel DP. The lower film PM may include a flexible plastic material. For example, the lower film PM may include polyethylene terephthalate.

In an embodiment, a first side surface DP_S1 of the display panel DP may be inclined with respect to a first lower surface DP_DF of the display panel DP. The first lower surface DP_DF may be adjacent to the lower module LM. The first side surface DP_S1 may extend in a direction parallel to the direction in which the first folding axis FX1 (see FIG. 4) extends. Referring to FIG. 5, the first side surface DP_S1 may be inclined with respect to the thickness direction DR3.

In a plan view, as the first side surface DP_S1 extending in a direction parallel to the extending direction of the first folding axis FX1 (see FIG. 3) is inclined, the first peripheral region F-NAA (see FIG. 1A) may be reduced. As described above, the first peripheral region F-NAA (see FIG. 1A) may be a region in which an image is not displayed.

In case that the electronic apparatus ED is folded, a slip may occur in at least some members (for example, the display panel DP, the protective layer PF, etc.) among members constituting the electronic apparatus ED. In case that the electronic apparatus ED is folded, the members constituting the electronic apparatus ED may slip in a direction (for example, the second direction DR2) perpendicular to an extending direction (for example, the first direction DR1) of the first folding axis FX1. In consideration of the slip, a space PS may be left so that the members constituting the electronic apparatus ED are not affected by the impact caused by touch with the housing HAU. Accordingly, the members constituting the electronic apparatus ED such as the display panel DP and the like may be spaced apart from the housing HAU, in the second direction DR2, by a distance DT1 (hereinafter, referred to as a first distance). The space PS may correspond to a portion of the first peripheral region F-NAA (see FIG. 1A).

Since the display panel DP according to an embodiment includes the first side surface DP_S1 which is inclined with respect to the first lower surface DP_DF, the display panel DP may be spaced relatively more apart from the housing HAU than a display panel including a first side surface perpendicular to a first lower surface, in case that a slip occurs during folding. The display panel DP according to an embodiment may be spaced relatively more apart from the housing HAU by including the inclined first side surface DP_S1. The first side surface DP_S1 which is inclined with respect to the first lower surface DP_DF may be spaced relatively more apart from the housing HAU than a first side surface perpendicular to a first lower surface. Here, the wording, ‘being spaced apart’ means ‘being spaced apart in a direction (for example, the second direction DR2) perpendicular to an extending direction of the folding axis FX1’. Accordingly, the space PS of the electronic apparatus ED according to an embodiment may be minimized, and thus the first peripheral region F-NAA (see FIG. 1A) may be reduced, thereby ensuring improved display quality.

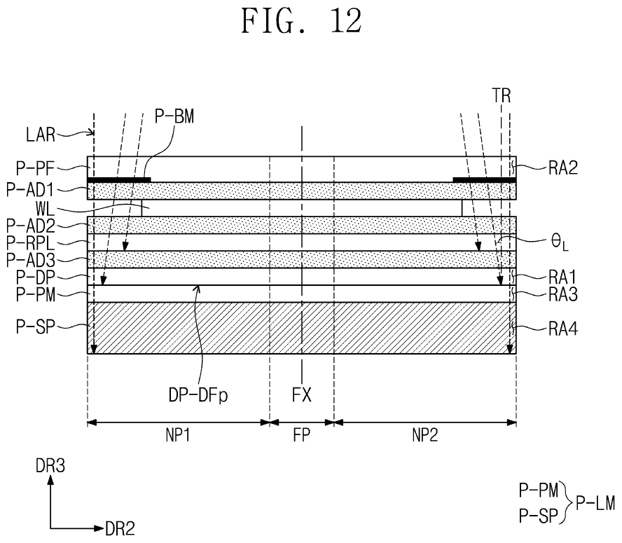

A first angle θ1 formed between the first side surface DP_S1 and the first lower surface DP_DF may be in a range of about 65° to about 80°. In a method for manufacturing a display panel according to an embodiment to be described below, the display panel DP may be formed by removing an edge region RA1 (see FIG. 12) of a preliminary display panel P-DP (see FIG. 12), and laser LAR (see FIG. 12) may be provided when removing the edge region RA1 (see FIG. 12). The laser LAR (see FIG. 12) may be provided at an angle θ_{L}. (see FIG. 12) in a range of about 10° to about 25° which is inclined with respect to the thickness direction DR3 so as to form the first side surface DP_S1 which is inclined with respect to the first lower surface DP_DF. Accordingly, the first angle θ1 formed between the first side surface DP_S1 and the first lower surface DP_DF may be in a range of about 65° to about 80°.

In case that the first angle θ1 is less than about 65°, the laser LAR (see FIG. 12) may be provided at an angle θ_{L}. (see FIG. 12) of greater than about 25°, and thus the window WL may be damaged because the window WL including a glass substrate is irradiated with the laser LAR. In case that the first angle θ1 is greater than about 80°, an inclination of the first side surface DP_S1 may decrease and a spaced distance between the display panel DP and the housing HAU may not be enough, and thus an impact may be applied to the display panel DP during folding. On the contrary, in an embodiment, the display panel DP including the first side surface DP_S1 and the first lower surface DP_DF satisfying the first angle θ1 in a range of about 65° to about 80° may exhibit excellent reliability, and contribute to reducing the first peripheral region F-NAA (see FIG. 1A) of the electronic apparatus ED.

In the electronic apparatus ED according to an embodiment, members (for example, the optical layer RPL, the protective layer PF, etc.) disposed on an upper portion of the display panel DP may each include an inclined side surface. A second side surface PF_S1 of the protective layer PF may be inclined with respect to a second lower surface PF_DF of the protective layer PF. On the first cross section parallel to the thickness direction DR3 and perpendicular to the first folding axis FX1 (see FIG. 3), the second side surface PF_S1 may be inclined with respect to the second lower surface PF_DF. In a plan view, the second side surface PF_S1 of the protective layer PF may extend in a direction parallel to the first direction DR1 in which the first folding axis FX1 (see FIG. 3) extends. In the protective layer PF, a second angle θ2 formed between the second side surface PF_S1 and the second lower surface PF_DF may be in a range of about 65° to about 80°. In case that the second angle θ2 is less than about 65°, the laser LAR (see FIG. 12) may be provided at an angle θ_{L}. (see FIG. 12) of greater than about 25°, and thus the window WL may be damaged because the window WL including a glass substrate may be irradiated with the laser LAR. In case that the second angle θ2 is greater than about 80°, a spaced distance between the protective layer PF and the housing HAU may not be enough, and thus an impact may be applied to the protective layer PF in case that the electronic apparatus ED is folded. On the contrary, in an embodiment, the protective layer PF including the second side surface PF_S1 and the second lower surface PF_DF satisfying the second angle θ2 in a range of about 65° to about 80° may exhibit excellent reliability, and contribute to reducing the first peripheral region F-NAA (see FIG. 1A) of the electronic apparatus ED.

In the second mode illustrated in FIG. 5, the first side surface DP_S1 of the display panel DP may be parallel to the second side surface PF_S1 of the protective layer PF. On a first cross section in the second mode, the first side surface DP_S1 of the display panel DP and the second side surface PF_S1 of the protective layer PF may be parallel with each other.

The window WL may include a glass substrate. A third side surface WL_S1 of the window WL may be perpendicular to a third lower surface WL_DF of the window WL. As described above, the window WL including a glass substrate may not be irradiated with the laser LAR (see FIG. 12), and the third side surface WL_S1 of the window WL may not be inclined. The third side surface WL_S1 of the window WL may be disposed more inward than the second side surface PF_S1 of the protective layer PF. The third side surface WL_S1 of the window WL may be disposed more inward than the first side surface DP_S1 of the display panel DP.

The optical layer RPL may be disposed between the display panel DP and the window WL. A fourth side surface RPL_S1 of the optical layer RPL may be inclined with respect to a fourth lower surface RPL_DF of the optical layer RPL. On the first cross section perpendicular to the first folding axis FX1 (see FIG. 3), the fourth side surface RPL_S1 may be inclined with respect to the fourth lower surface RPL_DF. In a plan view, the fourth side surface RPL_S1 of the optical layer RPL may extend in a direction parallel to the first direction DR1 in which the first folding axis FX1 (see FIG. 3) extends. In the optical layer RPL, a third angle θ3 formed between the fourth side surface RPL_S1 and the fourth lower surface RPL_DF may be in a range of about 65° to about 80°. The fourth side surface RPL_S1 of the optical layer RPL may be disposed more outward than the third side surface WL_S1 of the window WL.

In the second mode of the electronic apparatus ED illustrated in FIG. 5, the first side surface DP_S1 of the display panel DP may be parallel to the fourth side surface RPL_S1 of the optical layer RPL. The second side surface PF_S1 of the protective layer PF may be parallel to the fourth side surface RPL_S1 of the optical layer RPL. On the first cross section in the second mode, the first side surface DP_S1 of the display panel DP, the second side surface PF_S1 of the protective layer PF, and the fourth side surface RPL_S1 of the optical layer RPL may be parallel with one another.

A fifth side surface PM_S1 of the lower film PM may be perpendicular to a fifth lower surface PM_DF of the lower film PM. On the first cross section perpendicular to the first folding axis FX1 (see FIG. 3), the fifth side surface PM_S1 may be perpendicular to the fifth lower surface PM_DF.

A sixth side surface SP_S1 of the support plate SP may be perpendicular to a sixth lower surface SP_DF of the support plate SP. On the first cross section perpendicular to the first folding axis FX1 (see FIG. 3), the sixth side surface SP_S1 may be perpendicular to the sixth lower surface SP_DF.

In a method for manufacturing an electronic apparatus according to an embodiment to be described below, the laser LAR (see FIG. 12) to be provided to a preliminary lower film P-PM (see FIG. 12) and a preliminary support plate P-SP (see FIG. 12) may be provided in parallel to the thickness direction DR3. Accordingly, the fifth side surface PM_S1 of the lower film PM may be formed to be perpendicular to the fifth lower surface PM_DF of the lower film PM, and the sixth side surface SP_S1 of the support plate SP may be formed to be perpendicular to the sixth lower surface SP_DF of the support plate SP. However, the disclosure is not limited thereto.

A seventh side surface AD1_S1 of the first adhesive layer AD1 may be inclined with respect to a seventh lower surface AD1_DF of the first adhesive layer AD1. On the first cross section perpendicular to the first folding axis FX1 (see FIG. 3), the seventh side surface AD1_S1 may be inclined with respect to the seventh lower surface AD1_DF. An eighth side surface AD2_S1 of the second adhesive layer AD2 may be inclined with respect to an eighth lower surface AD2_DF of the second adhesive layer AD2. On the first cross section perpendicular to the first folding axis FX1 (see FIG. 3), the eighth side surface AD2_S1 may be inclined with respect to the eighth lower surface AD2_DF. A ninth side surface AD3_S1 of the third adhesive layer AD3 may be inclined with respect to a ninth lower surface AD3_DF of the third adhesive layer AD3. On the first cross section perpendicular to the first folding axis FX1 (see FIG. 3), the ninth side surface AD3_S1 may be inclined with respect to the ninth lower surface AD3_DF.

On the first cross section in the second mode, the seventh side surface AD1_S1 of the first adhesive layer AD1, the eighth side surface AD2_S1 of the second adhesive layer AD2, and the ninth side surface AD3_S1 of the third adhesive layer AD3 may be parallel with one another. On the first cross section in the second mode, the seventh side surface AD1_S1 of the first adhesive layer AD1, the eighth side surface AD2_S1 of the second adhesive layer AD2, the ninth side surface AD3_S1 of the third adhesive layer AD3, and the first side surface DP_S1 of the display panel DP may be parallel with one another.

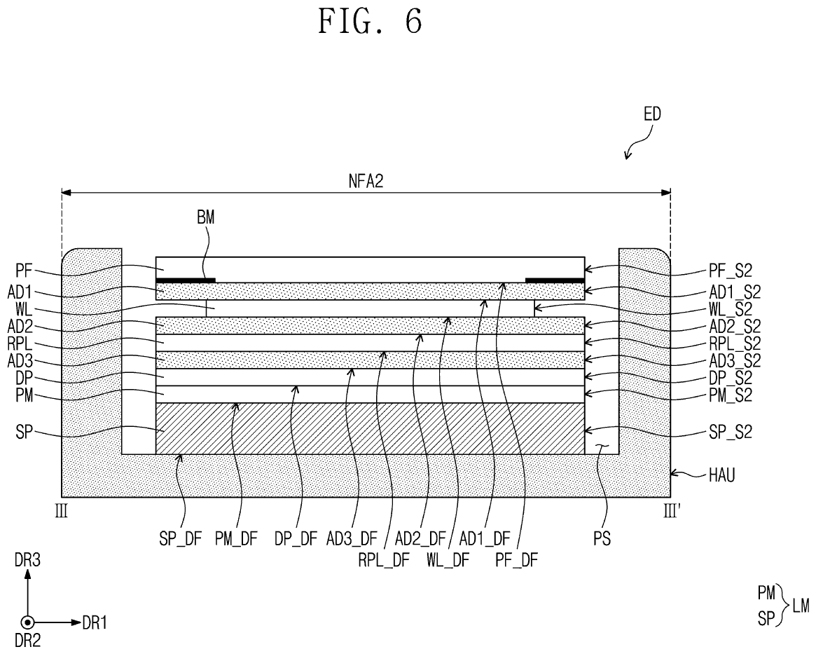

FIG. 6 is a schematic cross-sectional view taken along line III-III′ of FIG. 3. FIG. 6 may be a schematic cross-sectional view illustrating a configuration of the electronic apparatus ED in a second cross section. In this specification, the second cross section may be a cross-sectional view parallel to the thickness direction DR3, and parallel to a direction in which the first folding axis FX1 (see FIG. 3) extends (for example, the first direction DR1).

Referring to FIG. 6, a tenth side surface DP_S2 of the display panel DP may be perpendicular to the first lower surface DP_DF of the display panel DP. In a plan view, the tenth side surface DP_S2 may extend in a direction (for example, the second direction DR2) perpendicular to the direction in which the first folding axis FX1 (see FIG. 3) extends (for example, the first direction DR1). Accordingly, the tenth side surface DP_S2 of the display panel DP may not be inclined. As described above, in case that the electronic apparatus ED is folded, members constituting the electronic apparatus ED may slip in a direction (for example, the second direction DR2) perpendicular to the direction in which the first folding axis FX1 extends (for example, the first direction DR1). Since the tenth side surface DP_S2 of the display panel DP is a part in which a slip does not occur substantially during folding of the electronic apparatus ED, the tenth side surface DP_S2 may be formed not to be inclined.

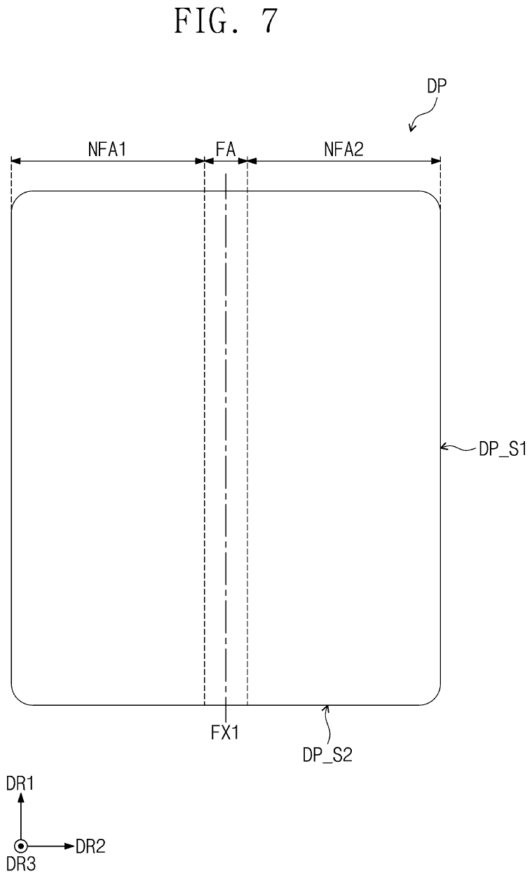

FIG. 7 is a plan view illustrating the display panel DP. Referring to FIG. 7, in a plan view, the first side surface DP_S1 of the display panel DP may extend in the first direction DR1 parallel to the direction in which the first folding axis FX1 extends. In a plan view, the tenth side surface DP_S2 of the display panel DP may extend in the second direction DR2 perpendicular to the direction in which the first folding axis FX1 extends. In a plan view, the first side surface DP_S1 of the display panel DP may intersect the tenth side surface DP_S2 of the display panel DP. In the display panel DP, the first side surface DP_S1 (see FIG. 5) may be inclined with respect to the first lower surface DP_DF (see FIG. 5), and the tenth side surface DP_S2 (see FIG. 6) may be perpendicular to the first lower surface DP_DF (see FIG. 6).

Referring to FIG. 6 again, an eleventh side surface PF_S2 of the protective layer PF may be perpendicular to the second lower surface PF_DF of the protective layer PF. The eleventh side surface PF_S2 of the protective layer PF may not be inclined. In a plan view, the eleventh side surface PF_S2 may extend in a direction (for example, the second direction DR2) perpendicular to the direction in which the first folding axis FX1 (see FIG. 3) extends (for example, the first direction DR1). As described above, in case that the electronic apparatus ED is folded, members constituting the electronic apparatus ED may slip in a direction (for example, the second direction DR2) perpendicular to the direction in which the first folding axis FX1 extends (for example, the first direction DR1). Since the eleventh side surface PF_S2 of the protective layer PF is a part in which a slip does not occur substantially during folding of the electronic apparatus ED, the eleventh side surface PF_S2 may be formed not to be inclined.

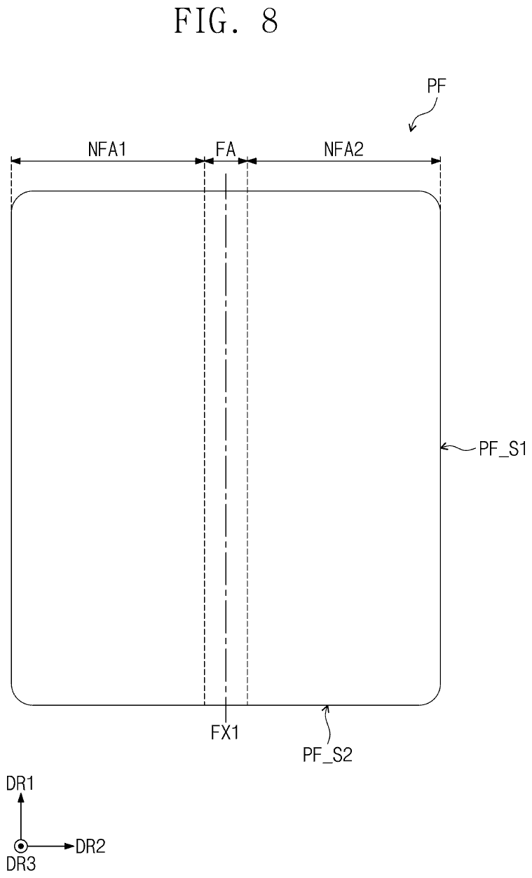

FIG. 8 is a plan view illustrating the protective layer PF. Referring to FIG. 8, In a plan view, the second side surface PF_S1 of the protective layer PF may extend in a direction parallel to the direction in which the first folding axis FX1 extends (for example, the first direction DR1). The eleventh side surface PF_S2 of the protective layer PF may extend in the second direction DR2 perpendicular to the direction in which the first folding axis FX1 extends (for example, the first direction DR1). In a plan view, the second side surface PF_S1 of the protective layer PF may intersect the eleventh side surface PF_S2 of the protective layer PF. In the protective layer PF, the second side surface PF_S1 (see FIG. 5) may be inclined with respect to the second lower surface PF_DF (see FIG. 5), and the eleventh side surface PF_S2 (see FIG. 6) may be perpendicular to the second lower surface PF_DF (see FIG. 6).

Referring to FIG. 6 again, a twelfth side surface WL_S2 of the window WL may be perpendicular to the third lower surface WL_DF of the window WL. In a plan view, the twelfth side surface WL_S2 of the window WL may intersect the third side surface WL_S1 (see FIG. 5) of the window WL.

A thirteenth side surface RPL_S2 of the optical layer RPL may be perpendicular to the fourth lower surface RPL_DF of the optical layer RPL. In a plan view, the thirteenth side surface RPL_S2 of the optical layer RPL may intersect the fourth side surface RPL_S1 (see FIG. 5) of the optical layer RPL. As described above, in case that the electronic apparatus ED is folded, members constituting the electronic apparatus ED may slip in a direction (for example, the second direction DR2) perpendicular to the direction in which the first folding axis FX1 extends (for example, the first direction DR1). Since the thirteenth side surface RPL_S2 of the optical layer RPL is a part in which a slip does not occur substantially during folding of the electronic apparatus ED, the thirteenth side surface RPL_S2 may be formed not to be inclined.

A fourteenth side surface PM_S2 of the lower film PM may be perpendicular to the fifth lower surface PM_DF of the lower film PM. In a plan view, the fourteenth side surface PM_S2 of the lower film PM may intersect the fifth side surface PM_S1 (see FIG. 5) of the lower film PM.

A fifteenth side surface SP_S2 of the support plate SP may be perpendicular to the sixth lower surface SP_DF of the support plate SP. In a plan view, the fifteenth side surface SP_S2 of the support plate SP may intersect the sixth side surface SP_S1 (see FIG. 5) of the support plate SP. In a plan view, the fourteenth side surface PM_S2 of the lower film PM may overlap the fifteenth side surface SP_S2 of the support plate SP. In the thickness direction DR3, the fourteenth side surface PM_S2 of the lower film PM may be parallel to the fifteenth side surface SP_S2 of the support plate SP.

A sixteenth side surface AD1_S2 of the first adhesive layer AD1 may be perpendicular to the seventh lower surface AD1_DF of the first adhesive layer AD1. In a plan view, the sixteenth side surface AD1_S2 of the first adhesive layer AD1 may intersect the seventh side surface AD1_S1 (see FIG. 5) of the first adhesive layer AD1.

A seventeenth side surface AD2_S2 of the second adhesive layer AD2 may be perpendicular to the eighth lower surface AD2_DF of the second adhesive layer AD2. In a plan view, the seventeenth side surface AD2_S2 of the second adhesive layer AD2 may intersect the eighth side surface AD2_S1 (see FIG. 5) of the second adhesive layer AD2.

An eighteenth side surface AD3_S2 of the third adhesive layer AD3 may be perpendicular to the ninth lower surface AD3_DF of the third adhesive layer AD3. In a plan view, the eighteenth side surface AD3_S2 of the third adhesive layer AD3 may intersect the ninth side surface AD3_S1 (see FIG. 5) of the third adhesive layer AD3.

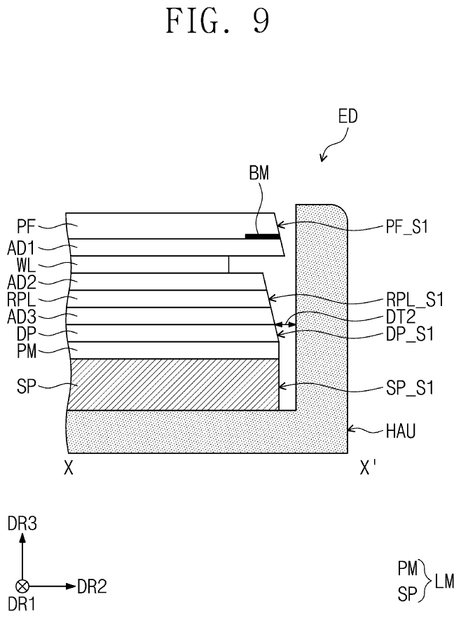

FIG. 9 is a schematic cross-sectional view taken along line X-X′ of FIG. 1C. FIG. 9 may be a schematic cross-sectional view illustrating a configuration of the electronic apparatus ED in the first mode. For example, FIG. 9 may be a schematic cross-sectional view illustrating a configuration of the electronic apparatus ED in a state in which the electronic apparatus ED is folded such that the first non-folding region NFA1 (see FIG. 1A) overlaps the second non-folding region NFA2 (see FIG. 1A) in a thickness direction. FIG. 9 schematically illustrates that as the electronic apparatus ED is folded, a slip may occur in members (for example, the display panel DP, the optical layer RPL, the protective layer PF, etc.) constituting the electronic apparatus ED and the members may move adjacent to the housing HAU.

A second distance DT2, illustrated in FIG. 9, between the display panel DP and the housing HAU may be shorter than the first distance DT1, illustrated in FIG. 5, between the display panel DP and the housing HAU. The second distance DT2 may be a distance in the second direction DR2 perpendicular to the first direction DR1 in which the first folding axis FX1 (see FIG. 3) extends. In case that the electronic apparatus ED is folded, a slip may occur in the display panel DP and the display panel DP may move adjacent to the housing HAU, resulting a decrease in the spaced distance (that is the second distance DT2) between the display panel DP and the housing HAU. In an embodiment, the electronic apparatus ED may include the display panel DP having the first side surface DP_S1 which is inclined, and thus the space PS (see FIG. 5) for preventing an impact applied to the display panel DP in case that the display panel DP is folded may be minimized. Accordingly, the electronic apparatus ED according to an embodiment may exhibit excellent display quality by reducing the first peripheral region F-NAA (see FIG. 1A).

The protective layer PF according to an embodiment may include the second side surface PF_S1 which is inclined, and the optical layer RPL may include the fourth side surface RPL_S1 which is inclined. Accordingly, the electronic apparatus ED according to an embodiment may exhibit excellent display quality by reducing the first peripheral region F-NAA (see FIG. 1A).

In the first mode in which the electronic apparatus ED is folded, the second side surface PF_S1 of the protective layer PF may not be parallel to the first side surface DP_S1 of the display panel DP. In the first mode in which the electronic apparatus ED is folded, the second side surface PF_S1 of the protective layer PF may be disposed more outward than the first side surface DP_S1 of the display panel DP. In case that the flexibility of the protective layer PF is greater than the flexibility of the display panel DP, a slip may be more likely to occur in the protective layer PF which has greater flexibility. Accordingly, in the first mode in which the electronic apparatus ED is folded, the second side surface PF_S1 of the protective layer PF may be disposed more outward than the first side surface DP_S1 of the display panel DP.

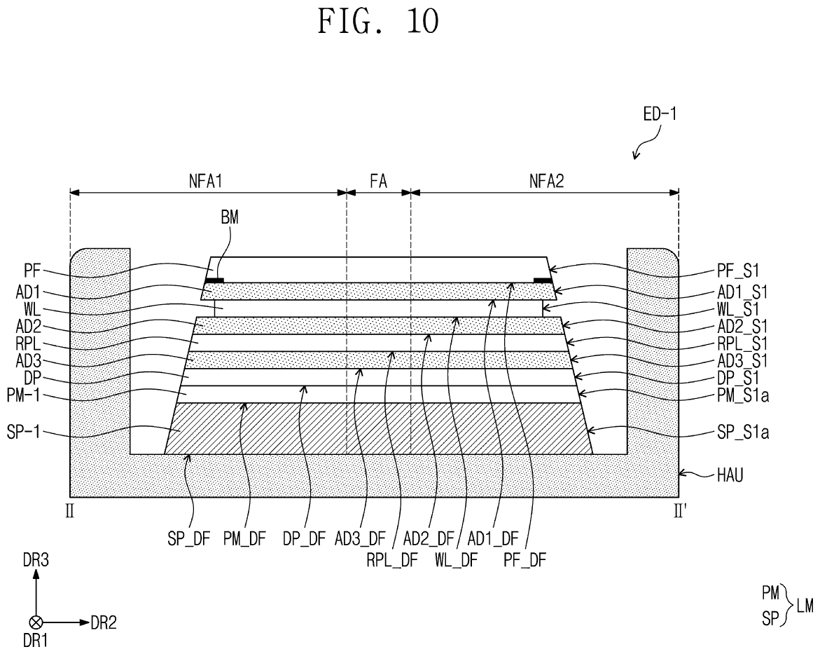

FIG. 10 is a schematic cross-sectional view illustrating an electronic apparatus ED-1 according to another embodiment of the disclosure. FIG. 10 may be a schematic cross-sectional view illustrating a configuration of the electronic apparatus ED-1 on a first cross section perpendicular to the first folding axis FX1 (see FIG. 3). FIG. 10 may be a schematic cross-sectional view illustrating a configuration of the electronic apparatus ED-1 in a second mode. For example, FIG. 10 may be a schematic cross-sectional view illustrating a configuration of the electronic apparatus ED-1 in a state in which the electronic apparatus ED-1 is unfolded so that the first non-folding region NFA1 (see FIG. 1A) is spaced apart from the second non-folding region NFA2 (see FIG. 1A).

In comparison with the electronic apparatus ED illustrated in FIG. 5, the electronic apparatus ED-1 illustrated in FIG. 10 may have a difference in terms of a support plate SP-1 and a lower film PM-1. In the description of FIG. 10, contents duplicated with those described reference to FIGS. 1A to 9 are not described again, but the following description will be focused on differences.

Referring to FIG. 10, a fifth side surface PM_S1a of the lower film PM-1 may be inclined with respect to a fifth lower surface PM_DF of the lower film PM-1. The fifth side surface PM_S1a of the lower film PM-1 may be parallel to the first side surface DP_S1 of the display panel DP. The fifth side surface PM_S1a of the lower film PM-1 may be parallel with the first side surface DP_S1 of the display panel DP. In an embodiment, the electronic apparatus ED-1 may include the lower film PM-1 having the fifth side surface PM_S1a which is inclined, thereby reducing the first peripheral region F-NAA (see FIG. 1A) and exhibiting excellent display quality.

A sixth side surface SP_S1a of the support plate SP-1 may be inclined with respect to a sixth lower surface SP_DF of the support plate SP-1. The sixth side surface SP_S1a of the support plate SP-1 may be parallel to the first side surface DP_S1 of the display panel DP. The sixth side surface SP_S1a of the support plate SP-1 may be parallel with the first side surface DP_S1 of the display panel DP. In an embodiment, the electronic apparatus ED-1 may include the support plate SP-1 having the sixth side surface SP_S1a which is inclined, thereby reducing the first peripheral region F-NAA (see FIG. 1A) and exhibiting excellent display quality.

The description of FIGS. 5 to 10 has been made for the electronic apparatus ED illustrated in FIG. 1A but may be similarly applied to the description of the electronic apparatus ED-a illustrated in FIG. 2A. The electronic apparatus ED-a illustrated in FIG. 2A may include members such as the display panel DP and the protective layer PF, which are illustrated in FIG. 3. The display panel DP and the protective layer PF may respectively have inclined side surfaces (for example, the first side surface DP_S1 and the second side surface PF_S1) parallel to a direction (for example, the second direction DR2) perpendicular to a direction in which the third folding axis FX3 (see FIG. 2A) extends (for example, the first direction DR1). Accordingly, the electronic apparatus ED-a illustrated in FIG. 2A may exhibit excellent display quality by reducing the peripheral region F-NAAa.

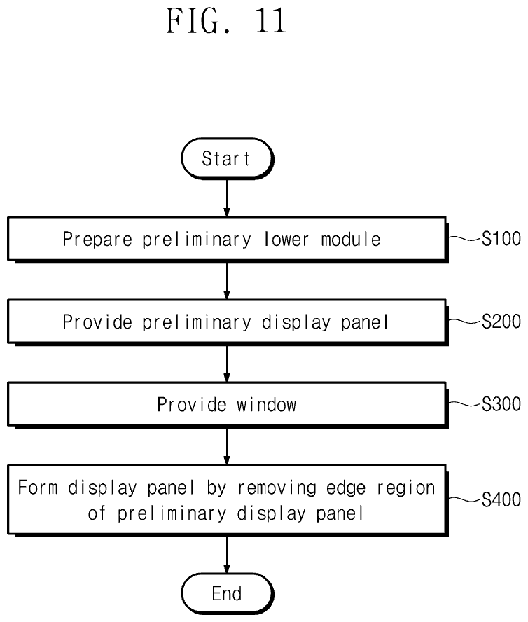

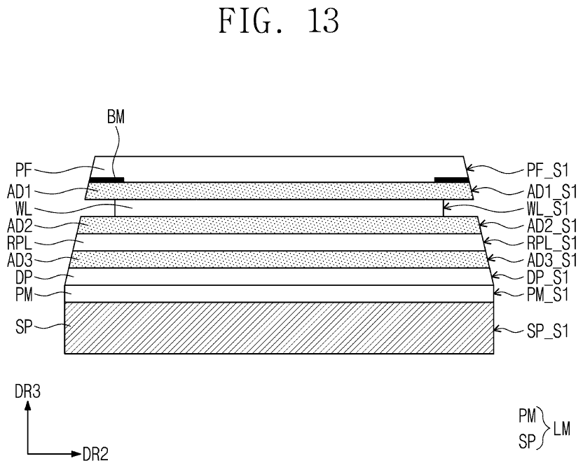

An electronic apparatus according to an embodiment may be manufactured by a method for manufacturing an electronic apparatus according to an embodiment. FIG. 11 is a flowchart illustrating a method of manufacturing an electronic apparatus according to an embodiment. FIG. 12 is a schematic cross-sectional view schematically illustrates operations of manufacturing an electronic apparatus according to an embodiment. FIG. 13 is a schematic cross-sectional view schematically illustrates operations of manufacturing an electronic apparatus according to an embodiment. FIGS. 12 and 13 schematically illustrate operations of manufacturing an electronic apparatus according to an embodiment. Hereinafter, in the description of FIGS. 11 to 13, contents duplicated with those described reference to FIGS. 1 to 10 are not described again, but description will be focused on differences.

Referring to FIG. 11, a method for manufacturing an electronic apparatus according to an embodiment may include preparing a preliminary lower module (S100), providing a preliminary display panel on the preliminary lower module (S200), providing a window on the preliminary display panel (S300), and forming a display panel by removing an edge region of the preliminary display panel (S400).

Referring to FIG. 12, a preliminary lower module P-LM may include a preliminary support plate P-SP and a preliminary lower film P-PM. A preliminary display panel P-DP may be provided on the preliminary lower module P-LM, and a window WL may be provided on the preliminary display panel P-DP. Before the window WL is provided, a preliminary third adhesive layer P-AD3, a preliminary optical layer P-RPL, and a preliminary second adhesive layer P-AD2 may be provided sequentially on the preliminary display panel P-DP. A preliminary first adhesive layer P-AD1, a preliminary printing layer P-BM, and a preliminary protective layer P-PF may be provided sequentially on the window WL. Laser LAR may be provided to the preliminary display panel P-DP, the preliminary protective layer P-PF, and the like. The laser LAR may be provided in the forming of a protective layer PF (see FIG. 13), a display panel DP (see FIG. 13), and the like. Hereinafter, description will be made with reference to FIGS. 12 and 13 together.

The laser LAR may be provided to the preliminary display panel P-DP and the members (for example, an optical layer RPL, a protective layer PF, etc.) disposed above the preliminary display panel P-DP at an angle θ_{L} in a range of about 10° to about 25° which is inclined with respect to a thickness direction DR3. The inclined angle θ_{L} of the laser LAR may be changed in consideration of the properties of members constituting the electronic apparatus ED (see FIG. 3). For example, the laser LAR may be provided at a more inclined angle θ_{L} to a member which is relatively more flexible among the members constituting the electronic apparatus ED (see FIG. 3). The laser LAR may be provided at a less inclined angle θ_{L} to a member which is relatively less flexible among the members constituting the electronic apparatus ED (see FIG. 3). Since a slip occurs more in a member with higher flexibility than in a member with lower flexibility in case that the electronic apparatus ED (see FIG. 3) is folded, the laser LAR may be provided to have a greater inclined angle θ_{L}.

A line TR of FIG. 12 may be an imaginary line, parallel to the thickness direction DR3 and is illustrated so as to indicate an angle θ_{L}. The laser LAR may be provided at an inclined angle θ_{L} so that a display panel DP formed from the preliminary display panel P-DP includes a first side surface DP_S1 which is inclined. The laser LAR may be provided at an inclined angle θ_{L} to a preliminary lower surface DP-DFp of the preliminary display panel P-DP. As the laser LAR is provided, a first edge region RA1 of the preliminary display panel P-DP may be removed and thus the display panel DP illustrated in FIG. 13 may be formed. The first edge region RA1 of the preliminary display panel P-DP may correspond to a portion of non-folding parts NP1 and NP2 of the preliminary display panel P-DP.

The preliminary display panel P-DP may be divided into a folding part FP, a first non-folding part NP1 adjacent to a side of the folding part FP, and a second non-folding part NP2 adjacent to another side of the folding part FP. The folding part FP may correspond to the folding region FA illustrated in FIG. 1A, the first non-folding part NP1 may correspond to the first non-folding region NFA1 illustrated in FIG. 1A, and the second non-folding part NP2 may correspond to the second non-folding region NFA2 illustrated in FIG. 1A. The folding part FP may be foldable with respect to a folding axis FX. The folding axis FX may correspond to the first folding axis FX1 illustrated in FIG. 1B and the second folding axis FX2 illustrated in FIG. 1D. The first edge region RA1 which is removed by providing the laser LAR may be a portion of the first and second non-folding parts NP1 and NP2.

A protective layer PF may be formed by removing a second edge region RA2 of the preliminary protective layer P-PF with the provision of the laser LAR. The laser LAR may be provided at an inclined angle θ_{L} so that the protective layer PF formed from the preliminary protective layer P-PF includes a second side surface PF_S1 which is inclined. The second edge region RA2 of the preliminary protective layer P-PF may overlap a portion of the non-folding parts NP1 and NP2 of the preliminary display panel P-DP in a thickness direction.

A lower module LM may be formed by removing edge regions RA3 and RA4 of the preliminary lower module P-LM with the provision of the laser LAR. The preliminary lower module P-LM may include the preliminary support plate P-SP and the preliminary lower film P-PM. A lower film PM may be formed by removing a third edge region RA3 of the preliminary lower film P-PM. A support plate SP may be formed by removing a fourth edge region RA4 of the preliminary support plate P-SP.

The laser LAR provided to the preliminary lower module P-LM may be provided in a direction parallel to the thickness direction DR3. The laser LAR provided to the preliminary lower module P-LM may not be inclined. Accordingly, in the lower module LM illustrated in FIG. 13, the support plate SP and the lower film PM may respectively include side surfaces SP_S1 and PM_S1 which are not inclined. In another embodiment, in case that the laser LAR is provided at an inclined angle θ_{L} to the preliminary lower module P-LM, the support plate SP-1 and the lower film PM-1, as illustrated in FIG. 10, may be formed.

The laser LAR may not be provided to the window WL. Since the window WL includes a glass substrate, the glass substrate may be damaged when irradiated with the laser LAR. Accordingly, the laser LAR may not be provided to the window WL.

The laser LAR may also be provided to the preliminary optical layer P-RPL at an inclined angle θ_{L}. Accordingly, an optical layer RPL formed from the preliminary optical layer P-RPL may include a fourth side surface RPL_S1 which is inclined. First to third adhesive layers AD1, AD2, and AD3 may be formed from the first to third preliminary adhesive layers P-AD1, P-AD2, and P-AD3 respectively. The laser LAR may be provided to the first to third preliminary adhesive layers P-AD1, P-AD2, and P-AD3 at an inclined angle θ_{L}. Accordingly, the first to third adhesive layers AD1, AD2, and AD3 may respectively include seventh to ninth side surfaces AD1_S1, AD2_S1, and AD3_S1 which are inclined. The laser LAR may be provided to the preliminary printing layer P-BM, and a printing layer BM may be formed from the preliminary printing layer P-BM.

A method for manufacturing an electronic apparatus according to an embodiment may include forming members (for example, a display panel, a protective layer, etc.) constituting the electronic apparatus by providing laser. The laser may be provided at an angle which is inclined with respect to a thickness direction. Accordingly, the electronic apparatus according to an embodiment manufactured by the method for manufacturing the electronic apparatus according to an embodiment may include a display panel having a side surface which is inclined.

The electronic apparatus according to an embodiment may include a folding region which is foldable with respect to a folding axis, and on a cross section perpendicular to the folding axis, a side surface of the display panel may be inclined with respect to a lower surface of the display panel. In an embodiment, the electronic apparatus including the display panel having an inclined side surface may have a reduced peripheral region in which an image is not displayed and thus exhibit excellent display quality.

A method for manufacturing an electronic apparatus according to an embodiment may include providing laser to form a display panel having an inclined side surface, thereby manufacturing an electronic apparatus having a reduced peripheral region.

An electronic apparatus according to an embodiment may exhibit excellent display quality since a peripheral region is reduced.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. An electronic apparatus divided into a folding region foldable with respect to a folding axis extending in a direction, a first non-folding region adjacent to a side of the folding region, and a second non-folding region adjacent to another side of the folding region, the electronic apparatus comprising:
a lower module;
a display panel disposed on the lower module; and
a window disposed on the display panel,
wherein in a first cross-sectional view parallel to a thickness direction of the display panel and perpendicular to the folding axis, a first side surface of the display panel is inclined with respect to a lower surface of the display panel.

2. The electronic apparatus of claim 1, wherein in the first cross-sectional view, an angle formed between the first side surface and the lower surface is in a range of about 65° to about 80°.

3. The electronic apparatus of claim 1, wherein in a second cross-sectional view parallel to the thickness direction and the folding axis, a second side surface of the display panel is perpendicular to the lower surface of the display panel.

4. The electronic apparatus of claim 3, wherein in a view perpendicular to the thickness direction, the first side surface of the display panel intersects the second side surface of the display panel.

5. The electronic apparatus of claim 1, further comprising:
a protective layer disposed on the window,
wherein in the first cross-sectional view, a first side surface of the protective layer is inclined with respect to a lower surface of the protective layer.

6. The electronic apparatus of claim 5, wherein in the first cross-sectional view, an angle formed between the first side surface of the protective layer and the lower surface of the protective layer is in a range of about 65° to about 80°.

7. The electronic apparatus of claim 5, wherein in a second cross-sectional view parallel to the thickness direction and the folding axis, a second side surface of the protective layer is perpendicular to the lower surface of the protective layer.

8. The electronic apparatus of claim 7, wherein in a view perpendicular to the thickness direction, the first side surface of the protective layer intersects the second side surface of the protective layer.

9. The electronic apparatus of claim 5, wherein
the electronic apparatus, in a first mode, is folded so that the first non-folding region overlaps the second non-folding region in the thickness direction, and in a second mode, is unfolded so that the first non-folding region is spaced apart from the second non-folding region, and
in the second mode, the first side surface of the display panel is parallel to the first side surface of the protective layer.

10. The electronic apparatus of claim 9, wherein in the first mode, the first side surface of the display panel is not parallel to the first side surface of the protective layer.

11. The electronic apparatus of claim 1, wherein
the window comprises a glass substrate, and
in the first cross-sectional view, a side surface of the window is perpendicular to a lower surface of the window.

12. The electronic apparatus of claim 1, further comprising:
an optical layer disposed between the display panel and the window,
wherein in the first cross-sectional view, a side surface of the optical layer is inclined with respect to a lower surface of the optical layer.

13. The electronic apparatus of claim 1, wherein the lower module comprises a support plate and a lower film disposed between the support plate and the display panel.

14. The electronic apparatus of claim 13, wherein in the first cross-sectional view, a side surface of the support plate is inclined with respect to a lower surface of the support plate.

15. A method for manufacturing an electronic apparatus, the method comprising:
preparing a preliminary lower module;
providing a preliminary display panel on the preliminary lower module;
providing a window on the preliminary display panel; and
forming a display panel by providing laser and removing an edge region of the preliminary display panel, wherein
the preliminary display panel is divided into a folding part foldable with respect to a folding axis extending in a direction and a non-folding part adjacent to the folding part,
the edge region of the preliminary display panel corresponds to a portion of the non-folding part, and
in a cross-sectional view parallel to a thickness direction of the display panel and perpendicular to the folding axis, a side surface of the display panel is inclined with respect to a lower surface of the display panel.

16. The method of claim 15, wherein the laser is provided in a state of being inclined with respect to the thickness direction at an angle in a range of about 10° to about 25°.

17. The method of claim 15, further comprising:
providing a preliminary protective layer on the window between the providing of the window and the forming of the display panel, wherein
in the forming of the display panel, a protective layer is formed by removing an edge region of the preliminary protective layer, and
the edge region of the preliminary protective layer overlaps a portion of the non-folding part in the thickness direction.

18. The method of claim 15, wherein
the window comprises a glass substrate, and
the laser is not provided to the window.

19. The method of claim 15, wherein in the cross-sectional view, an angle formed between the side surface and the lower surface of the display panel is in a range of about 65° to about 80°.

20. The method of claim 15, wherein in the forming of the display panel, a lower module is formed by removing, with the laser, an edge region of the preliminary lower module.
